(19) United States
(12) Patent Application Publication
(10) Pub. No.: US 2020/0406514 A1
(43) Pub. Date: Dec. 31, 2020

(54) Biodegradable dental floss pick manufacturing apparatus.

(71) Applicant: Jian Zhu, Westport, CT (US)

(72) Inventor: Jian Zhu, Westport, CT (US)

(21) Appl. No.: 16/455,137

(22) Filed: Jun. 27, 2019

(51) Int. Cl. B29C 45/03; A61C 15/04; B29C 45/00; B29C 45/26

(52) U.S. Cl. CPC B29C 45/03; A61C 15/046; B29L 2031/753; B29C 45/26; B29K 2003/00; B29C 45/0001

(57) ABSTRACT

This utility model discloses a manufacturing device of a dental floss pick, which comprises of an injection molding module, a cutting module, a carrying module and a storage module. The injection molding module is provided with a material chamber, a motor, a rotating shaft and screw, and heating is arranged on the outer periphery of the lower end of the material chamber. A nozzle is arranged at a lower end of the material chamber, an upper mold and a lower mold are arranged under the nozzle, and a shape forming mold is arranged between the upper mold and the lower mold. The cutting module encompasses of cutters directly under the blade cutter; a clamping robot is arranged between the injection molding module and the cutting module, and a suction cup robot is arranged between the cutting module and the storage module. Through the whole process, the automated carrying module is used to carry out the handling and stacking operation of the product. The whole production process realizes the automatic operation of the equipment, which greatly improves safety and production efficiency; furthermore the equipment in the utility model is naturally degradable. Thermoplastic starch plastics are produced as raw materials and the products do not pollute the environment.

### TECHNICAL FIELD

This utility model relates to a plastic product production equipment, in particular, a dental floss pick's manufacturing equipment.

### BACKGROUND TECHNOLOGY

With the improvements of quality of life, people often use tooth picking tools when eating. Currently available to the mass market are toothpicks, floss picks, etc., because floss picks are less harmful to the gums hence they are widely used. As a daily disposable consumable, floss picks are generally produced by an injection molding process. The process of formulating a semi-finished part of a certain shape consists of injecting, pressing, cooling, detaching, etc., raw materials. Dental floss pick injection molding materials are mostly pp plastic, ps plastic or abs plastic, these materials are non-degradable and are one time use consumables; which results in a huge amount of use and difficult to recycle and reuse. After being used and discarded into the natural environment, they cannot be degraded, which will have a tremendous destructive effect on the environment. Meanwhile the dental floss pick's production equipment is mostly manual and semi-automatic operation, which leads to poor production safety and low efficiency.

### UTILITY MODEL CONTENT

The purpose of this utility model is to provide manufacturing equipment for dental floss picks, which aims to solve the aforementioned issues described in the background technology.

To achieve the aforementioned objective, the present invention provides the following technical solutions:

A manufacturing equipment for a dental floss pick, comprising of an injection molding module, a cutting module, a carrying module and a storage module. In between these modules there is a carrying module capable of automatically loading and unloading operations.

As a further solution of the utility model, the outer side of the material chamber of the injection molding module is connected with a funnel through a feed valve. There is a motor to supply power located at the upper portion of the chamber, a rotating shaft is inside the chamber, and a screw is disposed between the rotating shaft and the chamber.

The screw is fixed on the rotating shaft, and a heater is arranged around the lower outer surface of the material chamber. A nozzle is then connected to the lower end of the material chamber.

Furthermore underneath the nozzle comprises of an upper mold and a lower mold. The upper mold has a through hole used for feeding raw materials. In between the upper and lower molds there is a shape forming mold.

Next, at the center of the shape forming mold there is a main material channel, with two rows of symmetrically arranged cavities. In between the main material channel and cavities there is a branch material channel.

As a further aspect of the present invention, the cutting module includes a blade cutter and underneath there is a mold cutting model. There are blade cutters corresponding to the main material channel and branch material channel used to sever each piece.

As a further solution of the utility model, a clamping robot is arranged between the injection molding module and the cutting module, where the cutting is performed. A suction cup robot is used between the cutting module and the storage module.

As a further solution of the present invention, the pressure at which the nozzle is opened in the injection molding module is 70-110 MPa.

As a further solution of the present invention, the raw material used in the injection molding module is a thermoplastic starch plastic.

Compared with the current technology, this utility model has additional benefits. The melted raw material is injected into the mold through the injection module via pressurization. After the molding process, it is then handled through the cutting module, and then you receive a complete dental floss pick. Then through the carrying module the finished product is carried to the storage module. This entire production process enables automatic operation of the equipment. Thus greatly improving safety and efficiency. The equipment in this utility model is produced by using a naturally degradable thermoplastic starch plastic as a raw material hence not to pollute the environment.

### FIGURES DESCRIPTION

FIG. 1 is a schematic view showing the structure of an injection molding process of a manufacturing apparatus for a dental floss pick.

FIG. 2 is a schematic view showing the structure of a mold in a manufacturing apparatus of a dental floss pick.

FIG. 3 is a structural schematic view showing a process of taking a mold in a manufacturing apparatus of a dental floss pick.

FIG. 4 is a structural schematic view of a cutting process in a manufacturing apparatus of a dental floss pick.

In the figure: 1-raw material, 2-motor, 3-screw, 4-heater, 5-upper mold, 6-lower mold, 7-shape forming mold, 8-clamp robot, 9-blade cutter, 10-mold cutting model, 11-suction robot, 12-funnel, 13-feed valve, 14-nozzle, 15-stringing tool, 16-material chamber, 17-rotating shaft, 71-main channel, 72-mold cavity, 73-branch channel, 151-base, 152-guide rod.

### DETAILED IMPLEMENTATION

The below will help describe this utility model implementation through the use of figures. Throughout the description, it is apparent that the described examples are only a part of the embodiments of the invention, and not all of the use variations.

Based on the present implementation examples, those of ordinary technician in the field can also obtain the following without creative work. All other embodiments obtained are within the scope of protection.

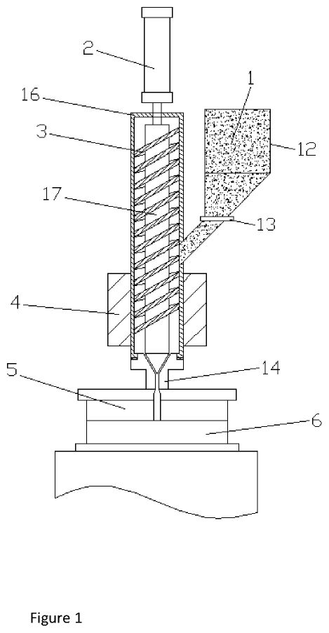

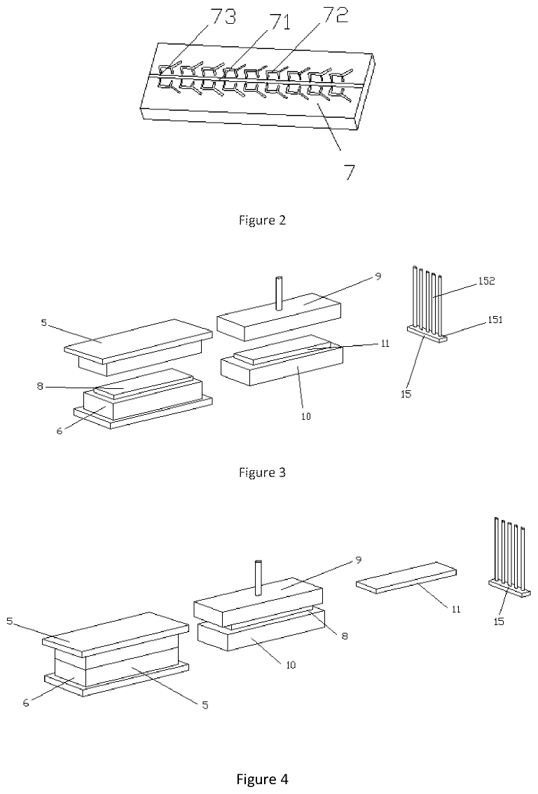

Referring to FIGS. 1 to 4, in an embodiment of the present invention, a dental floss manufacturing apparatus includes an injection molding module, a cutting module, carrying module and storage module. Through the implementations of these modules there is a dynamic loading and unloading handling process that allows the entire production process to be autonomous.

The dental floss pick material (1) in the injection molding module is placed in a funnel (12), and the raw material (1) is a thermoplastic starch plastic. The lower end of the funnel (12) is connected to the side of the material chamber (16) through the feed valve (13), and is powered through a motor (2) located on the upper end of the material chamber (16). The motor (2) drives the rotating shaft (17) and the screw (3) located on the rotary shaft (17). The screw (3) takes the raw material (1) and pushes into the heater (4) (temperature setting range 160 degrees-260 degrees), the molten material (1) is pressurized by the subsequent thrust. The nozzle (14) injects this molten material into the upper mold (5) and the lower mold (6) located underneath it; and 70-100 MPa is the pressure used to open the nozzle (14). In between the upper mold (5) and lower mold (6) there is a shape forming mold (7). The molten material (1) is advanced along the reserved upper mold (5) passage into the shape forming mold (7).

Specifically, the raw material (1) is first flown through the main channel (71) into the shape forming mold (7), and then along the branch channel (73), into the mold cavity (72), filling it. The raw material (1) in the mold cavity (72) is cooled for roughly 10-30 seconds and then the entire injection module process is complete.

After the injection molding is completed, the upper mold (5) is separated from the lower mold (6), and the suction robot (11) in the carrying module will suck out the completed dental floss pick and carry it into the mold cutting model (10). Then the blade cutter (9) presses down the mold cutting model (10) from above. The blade cutter (9) has cutters located corresponding to the main channel (71) and the branch channel (73), on the shape forming mold (7). Whereby the excess materials (1) from these channels are cut off. The clamping robot (8) takes the already cut out dental floss picks and allocates the pre-determined amount into the storage module.

Furthermore the storage module is composed of multiple stringing tools (15). Stringing took (15) is comprised of a rectangular base (151). Atop the rectangular base (151) there is a row of 5 guide rods (152). The dental floss picks can be conveniently placed along the guide rods (152).

The working principle of this utility model is: press-molding the heated raw material (1) into the mold through an injection molding module. After the shaping is completed, the finished dental floss pick can be obtained through separation by the cutting module. Then the finished product is placed in the storage module through the carrying module. The entire handling and stacking operations are automated, which greatly increases efficiency and production safety.

It will be apparent to those skilled in the field that the present invention is not limited to the details of the above exemplary embodiments, and the present invention can be implemented in other specific forms without departing from the spirit or essential characteristics of the invention. Therefore the above should be regarded as specific examples rather than limited uses. The scope of this utility model is defined by the appended claims rather than the above descriptions, and is therefore intended to be used in conjunction with variations. No reference signs in the claims should be construed as limiting to the claims involved. In addition, it should be understood that although the description is written in terms of examples, not every embodiment includes only one independent technical solution. The described examples are only used for the sake of clarity and those skilled enough can find other creative uses with it.

1. A manufacturing device for a dental floss pick, comprising of an injection molding module, a cutting module, a carrying module and a storage module. The utility model is characterized in that the injection molding module, the cutting module and the storage module are arranged to realize automatic loading and unloading and handling operations.

2. The apparatus for manufacturing a dental floss pick according to claim 1: wherein the injection molding module main chamber (16) outer side is connected to a funnel (12) through the feed valve (13); and the upper part of the material chamber (16) is provided with a motor (2) for supplying power. A rotating shaft (17) is disposed inside the chamber (16), and a screw (3) is used between the rotating shaft (17) and the chamber (16). The screw (3) is fixed on the rotating shaft (17), and a heater (4) is placed around the outer lower side near the bottom of the chamber (16). A nozzle (14) is connected to the lower end of the chamber (16).

3. The apparatus for manufacturing a dental floss pick according to claim 2, wherein said nozzle (14) comprises of upper mold (5) and lower mold (6). On the upper mold (5) there is a through hole set for material feeding and on the lower mold (6) there is a shape forming mold (7).

4. The apparatus for manufacturing a dental floss pick according to claim 3: wherein said form shaping mold (7) is centered with a main channel (71) and a row of molding cavities (72) are symmetrically arranged on both sides. A branch channel (73) is provided between them.

5. The apparatus for manufacturing a dental floss pick according to claim 4, key characteristics of this cutting module consists of a blade cutter (9) located underneath the mold cutting model (10). Blade cutter (9) corresponds to above shape forming mold (7) and a cutter is provided in the area of the main channel (71) and branch material channel (73)

6. The apparatus for manufacturing a dental floss pick according to claim 5, wherein said injection molding module and cutting module. A clamping robot (8) is arranged between the clamping module and the storage module with a suction cup robot (11).

7. The apparatus for manufacturing a dental floss pick according to claim 6, wherein the nozzle (14) of the injection molding module is located. The opening pressure is 70-110 MPa.

8. The manufacturing apparatus according to claims 1 to 7, in which thermoplastic starch plastic is used in the injection molding module as a raw material (1).
